(19) United States
(12) Patent Application Publication
(10) Pub. No.: US 2003/0097343 A1
(43) Pub. Date: May 22, 2003

(54) Secured purchase card transaction

(76) Inventor: John Pinizzotto, East Meadow, NY (US)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 09/534,681

(22) Filed: Mar. 24, 2000

(51) Int. Cl. G06F 17/60

(52) U.S. Cl. 705/75

(57) ABSTRACT

A secure Internet transaction processing system in which individual ones of a plurality of customers order from a targeted one of a plurality of merchants through a processing center. The customer credit card and debit card information is encrypted at the customer ordering terminal and sent to the processing center over the Internet where it is decrypted for the purpose of undertaking a standard procedure to verify payment capability. The order is then placed by the processing center together with payment capability confirmation over the Internet with the targeted merchant thereby avoiding access at the merchant's station to the customer's purchase card identification numbers.

### BACKGROUND OF THE INVENTION

The potential hazard of a security breach in the use of a debit card or a credit card from home for ordering goods or services over the Internet is a problem that inhibits the use of purchase cards (that is, credit cards and debit cards). The security problem is particularly severe when it comes to the risks that customers have in the use of debit cards. There appears to be no existing home customer terminals through which a purchase card may be swiped to effect a purchase of goods or services from a merchant or to provide payment for ongoing services.

When a purchase card is used from home for an Internet purchase, the customer enters the card number through the computer keyboard. The card number is then directly available to the merchant and available to one who can hack the merchant's list. Unfortunately, credit card fraud is common. The regulations and business practice tend to impose the loss partially on the cardholder and the balance on the credit card company. Current regulations put a debit cardholder at great risk. The entire balance in the bank of a debit card holder may be at risk.

Many small and medium size merchants are reluctant to sell over the Internet because of the lack of assured payment. The credit card mode of payment does not result in a final sale. The customer has the opportunity to change his or her mind. The use of debit cards would overcome that problem. But, because of the lack of security on the Internet, debit cards are not widely used. There appears to be no effort now being made to provide this debit card service to the smaller merchants.

Accordingly, a major purpose of this invention is to provide a secure marketing system for purchase cards such as credit cards or debit cards.

It is a related purpose of this invention to facilitate merchant payment and to encourage merchant willingness to become part of Internet commerce.

### BRIEF DESCRIPTION

In brief, the embodiment illustrated is a secured purchase card transaction system in which a large number of customer ordering terminals are involved as well as a large number of merchant stations. For each customer ordering terminal, there is a facility for a purchase card swipe to obtain the card number and also a keyboard or the like to permit entering a purchase or identification number (PIN). At each customer ordering terminal, there is an encryption module which encrypts the swiped purchase card number as well as the PIN number. This encrypted information together with the customer ordering information identifying a merchant and a product is sent over the Internet to a processing center.

At the processing center, the debit or credit payment capability is confirmed in a standard fashion with appropriate banks and credit card companies. When confirmation is obtained, the processing center prepares appropriate information for a merchant including details of the purchase order and a report verifying customer payment capability. This information is then sent over the Internet to the merchant targeted by the customer order. The processing center also prepares a purchase verification notice to the customer which is sent over the Internet to the customer originating the order. Where debit cards are used and the payment is received from a bank, the processing center provides a financial holding center to hold the payment for the targeted merchant.

### BRIEF DESCRIPTION OF THE DRAWINGS

FIG. 1 is a high level block arrangement illustrating the system of this invention and particularly illustrates the relationship of the processing center to the customer and the merchant.

FIG. 2 is a block flow diagram illustrating the system of this invention in relationship to a particular customer ordering from a particular merchant.

FIG. 3 is a block diagram of a typical customer ordering station.

### DESCRIPTION OF THE PREFERRED EMBODIMENTS

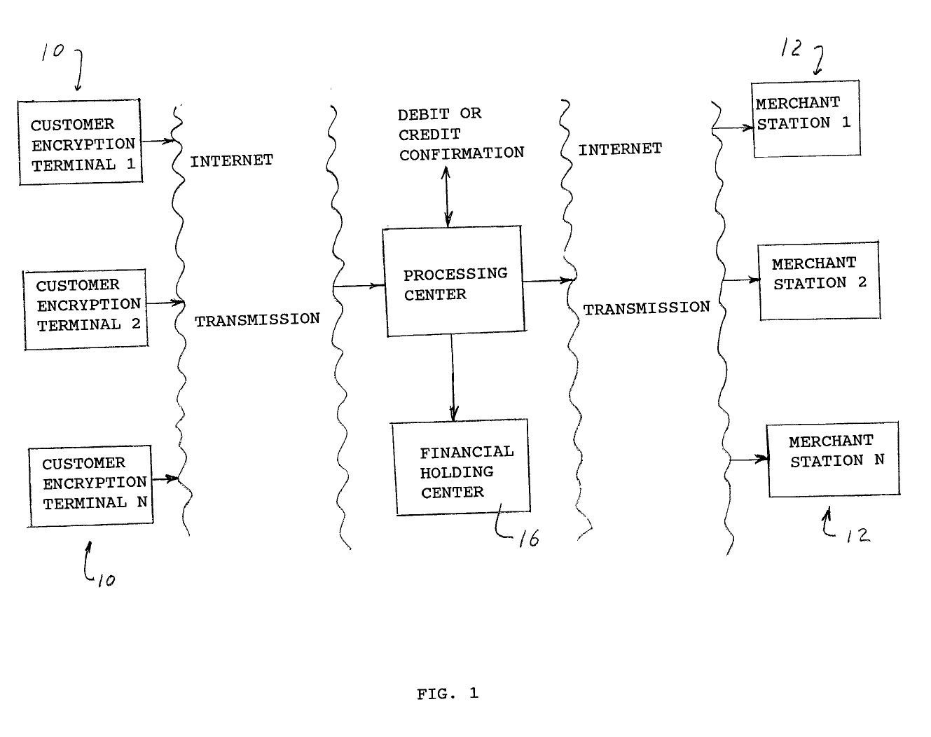

FIG. 1 illustrates the system of this invention in which a plurality of customers have encryption terminals 10 such as terminals 1, 2 . . . N.

In addition, there are a plurality of merchant stations 12 represented by the merchant stations 1, 2 . . . N.

A processing center 14 is at the heart of the communication between the customer terminals 10 and the merchant stations 12. This processing center 14 is central to the security provided to each customer 10 and the assurance of payment provided to each merchant 12. As indicated in FIG. 1, Internet transmission is employed to provide the security and assurance of payment functions between a plurality of customers and a plurality of merchants.

Essentially, any one of the customers 10 sends an order over the Internet together with an appropriately encrypted debit card or credit card number with, where required, an appropriately encrypted personal identification number (PIN). The encrypted information can be decrypted only at the processing center 14. The processing center 14, with the decrypted information, obtains credit or debit information on the particular customer. Where the customer is using a debit card, the information can include bank confirmation that the amounts involved are in the customer's bank account. The system provides the capability to transfer the amount involved to a financial holding center 16 for the merchant; which holding center is under the control of the processing center 14.

Once the credit information or debit information has been confirmed, the processing center 14 then sends an appropriate statement to the designated merchant 12 over the Internet and provides the merchant with information as to what has been ordered, identifying the customer and confirming that payment or credit has been made or is available.

It is worth noting that none of the merchant stations receive the credit card number or debit card number or PIN number nor even the encryption of those numbers.

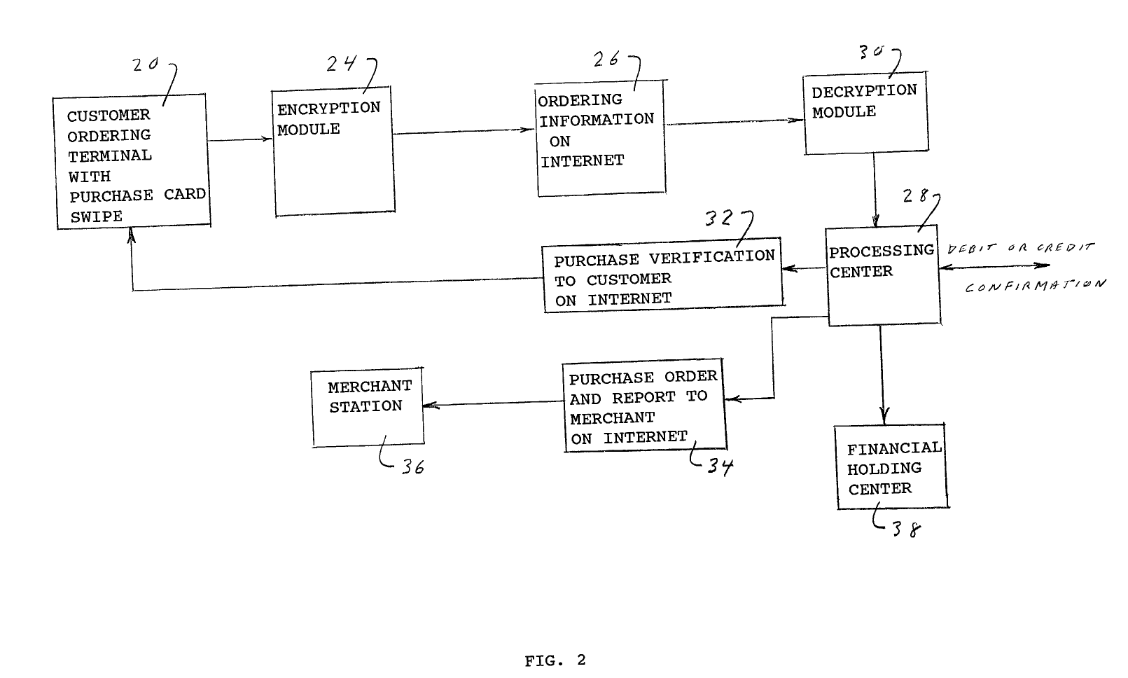

With more specific reference to FIG. 2, each customer ordering terminal 20 has a card swipe to accept either a credit card or a debit card identification and also has a keyboard or the like for the entering of a personal identification number (PIN). At each customer ordering terminal 20 there is an encryption module 24 that is used to encrypt the card identification and the PIN number where such is required.

As used herein, the term “purchase card” will refer to either a credit card or to a debit card.

When the purchase card is a credit card, the credit card number will be swiped through the customer ordering terminal 20 and that number will be encrypted by the module 24.

Where the purchase card is a debit card, the customer ordering terminal swipe will detect the debit card number and the customer ordering terminal will have a keyboard or other similar means for the debit card owner to insert their personal identification number (PIN). In that case, the encryption module 24 will encrypt both the debit card identification number and the PIN.

The customer ordering terminal after encryption of the credit identification numbers sends out the ordering information on the Internet as indicated at 26; which ordering information includes the encrypted purchase card identification and PIN number, where required. This ordering information is received at a processing center 28. The processing center 28 includes a decryption module 30 for decrypting the encrypted card number and PIN number.

The processing center 28 then makes an appropriate inquiry of a bank or credit processing station concerning the availability of the funds in the bank for a debit card or the credit available for a credit card. The processing center 28 then receives confirmation from the bank or the credit station.

After the processing center 28 receives the bank or credit confirmation, the processing center generates a purchase verification to the customer indicated at 32 which is sent over the Internet to the customer. The processing center also generates a purchase order and report to the merchant as indicated at stage 34 which is sent to the designated merchant station 36. The report to the merchant provides the merchant with two essential types of information.

The first is an identification of the customer and of the item or service being ordered.

The second is verification of a bank payment to cover a debit card or credit availability to cover a credit card.

The processing center 28 may also provide a financial holding center 38 in which the amounts being transferred by a debit card from a bank for a merchant may be held for the merchant.

The stage where the processing center 28 makes inquiry, to determine if debit card funds are available or if credit is available and to receive information concerning such, is a known processing stage that is currently undertaken by merchants and/or banks that accept credit cards and/or debit cards. Accordingly, there is no need to go into a discussion of the processing. It might be noted that there is a 48 hour hold put on the transfer of debit card funds.

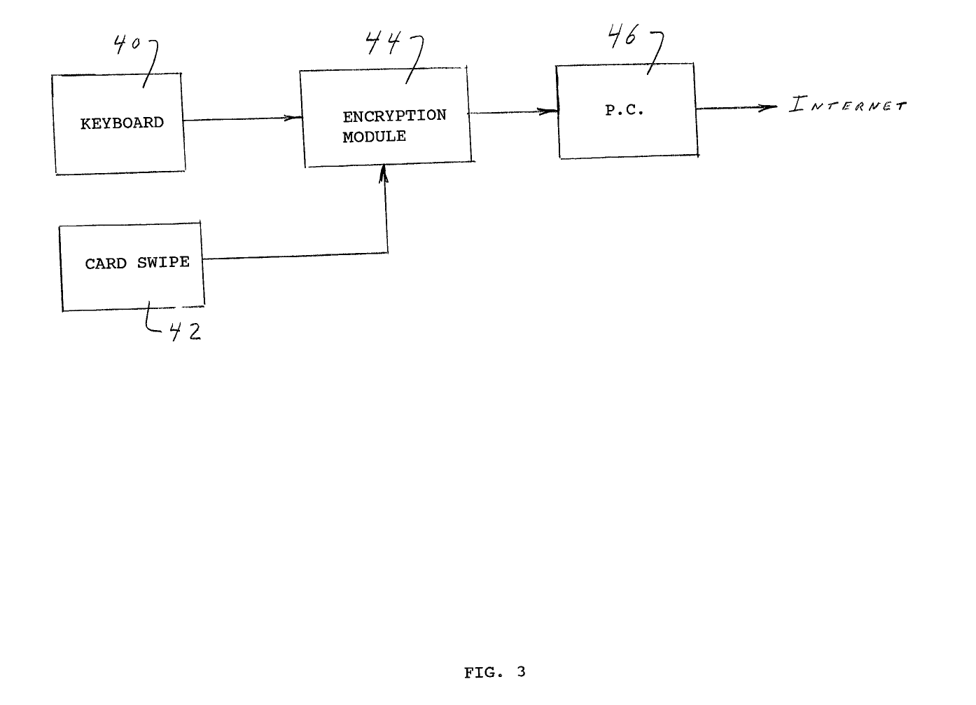

As shown in FIG. 3, the customer encryption terminal 10, in one embodiment, essentially involves a PC keyboard 40 and a card reader 42, both of which provide inputs to an encryption module 44. The output of the encryption module 44 is applied to a personal computer (PC) 46. In the embodiment illustrated, the encryption module 44 will have to provide pass through capability for the keyboard input to the PC. In that embodiment, the encryption module would therefore be plugged into the keyboard port of the personal computer. It is presently contemplated that it would be more user friendly to incorporate the encryption module 44 and card reader 42 in a single unit so that the user will simply have to unhook the keyboard from the PC and insert the combined module between keyboard and PC.

A standard card reader is preferred for reasons of economy and performance. The encryption module itself can employ any one of a number of known encryption algorithms appropriate to the level of security desired for the system.

Although not shown, it should be noted that in order to use a standard PC, there will be the need to employ a CD ROM input to the PC in order to provide appropriate directories and, most importantly, to provide a predetermined screen display interface with the customer.

The transmission and reception of information over the Internet requires only known types of modem and other equipment as a component of the terminals 10, center 14 and stations 12 and thus are not described in any detail herein.

Traditionally, individual customers have gone through a merchant in order to place their order and then the merchant would undertake the validation of the purchase card. As described above, this system decouples the set of customers from the set of merchants as well as decoupling each individual customer from the targeted merchant. The customer's security is greatly enhanced because no amount of hacking at or through a merchant's station would provide the customer's purchase card identification. As a consequence of enhanced customer purchase card security, debit card transactions are facilitated or encouraged and merchants may find enhanced value in Internet transactions.

What is claimed is:

1. A secured purchase card transaction system comprising:
a plurality of customer ordering terminals, each of said terminals having a purchase card swipe and purchaser identification number (PIN) entering capacity,
a first encryption module at each of said customer ordering terminals to encrypt a swiped purchase card number and whatever PIN number has been inputted to thereby provide encrypted identification information,
a processing center,
means to transmit customer ordering information from each of said ordering terminals, together with said encrypted identification information, over the Internet, each customer ordering information including a designated merchant identification,
a decryption module at said processing center, said decryption module providing the purchase card identification number and whatever PIN number is involved,
whereby said processing center can confirm customer payment capability,
said processing center in response to customer payment capability confirmation, generating a first statement to the designated merchant to provide said customer ordering information and to confirm customer payment capability and also to generate a purchase verification to the customer confirming the placement of the order,
a plurality of merchant stations, each of said merchant stations corresponding to a separate designated merchant, each of said stations adapted to receive said first statement addressed to the designated merchant, and
means at said processing center to transmit said first statement to the designated merchant over the Internet and to transmit said purchase verification to the relevant customer over the Internet.

2. The system of claim 1 wherein said purchase card is a debit card and said customer payment validation is a bank confirmation of a customer account having sufficient funds to cover the purchase.

3. The system of claim 2 further comprising:
a financial holding center for retaining any validated debit card amounts.

4. In a system for effecting transactions between any one of a plurality of customers and any one of a plurality of merchants over the Internet employing customer purchase card information encrypted at each customer's terminal, the secured transaction improvement comprising:
a processing center adapted to receive over the Internet customer ordering information from each of said customer encryption terminals including said encrypted identification information,
a decryption module at said processing center, said decryption module providing the purchase card identification number and whatever PIN number is involved,
said processing center adapted to process purchase card payment verification,
said processing center adapted to transmit over the Internet to any designated one of said plurality of merchants a purchase order report identifying the customer and the purchase and providing verification of payment or credit.

5. The secured purchase card transaction system improvement of claim 4 wherein: said processing center further provides purchase verification over the Internet to the customer.
